(19) United States
(12) Patent Application Publication
(10) Pub. No.: US 2002/0087366 A1
(43) Pub. Date: Jul. 4, 2002

(54) Tentative-hold-based protocol for distributed transaction processing

(76) Inventors: Timothy R. Collier, Phoenix, AZ (US); Srinivasan Krishnamurthy, Chorder, AZ (US); George P. Moakley, Phoenix, AZ (US); Jerry W. Roberts, Phoenix, AZ (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/753,033

(22) Filed: Dec. 30, 2000

(51) Int. Cl. G06F 17/60

(52) U.S. Cl. 705/5

(57) ABSTRACT

Apparatus and methods are provided for a tentative-hold-based protocol for distributed transaction processing. According to one embodiment, a distributed transaction coordinator receives information regarding an atomic distributed transaction representing an aggregation of multiple discrete transactions for resource items that span two or more network resources. The distributed transaction coordinator places a tentative hold on each of the resource items by causing a tentative hold record to be created and associated with each of the discrete transactions. The tentative holds operate in a non-mutually exclusive manner, thereby allowing the same resource item to be tentatively held by more than one transaction. Finally, after successfully gaining the tentative holds on each of the resource items and receiving a confirmation from the user regarding the atomic distributed transaction, the distributed transaction manager attempts to direct the completion of the atomic distributed transaction by conventional means (e.g., by employing the 2PC protocol, Microsoft Transaction Service (MTS), IBM's CICS, BEA Tuxedo, or other existing transaction completion mechanism).

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The invention relates generally to distributed transaction management and processing. More particularly, the invention relates to a new protocol for distributed transaction processing that allows tentative-holds to be placed on discrete elements of an atomic distributed transaction.

2. Description of the Related Art

In order to ensure atomicity, concurrency, isolation and durability (or ACID properties) of distributed transactions, e.g., transactions that span multiple databases or information systems within an enterprise, a Two-Phase Commit (2PC) protocol is typically employed. The 2PC methodology has been used successfully since the 1980s for hotel and airline reservations, stock market transactions, banking applications and credit card systems.

Two-Phase Commit protocols include two distinct processes, a “prepare phase” (sometimes called the “voting phase”) and a “commit phase” (also referred to as the “completion phase”). Briefly, the first phase, the prepare phase, is initiated in response to a transaction request. During the prepare phase all participants or cohorts (e.g., distributed resources of a client/server architecture) promise to commit or rollback the transaction. After the prepare phase, the commit phase commits or rolls back the transaction based upon the responses from the participants. If all the participants respond that they are prepared, then a coordinating process or entity (typically referred to as the “global coordinator,” the Two-Phase Commit coordinator,” or simply the “coordinator”) requests all participants to commit the transaction. If, however, one or more participants cannot prepare or there is a system component failure, the coordinator asks all participants to roll back the transaction. As discussed further below, the greatest disadvantage of the 2PC protocol is the fact that it is a blocking protocol. That is, a participant will block while it is waiting for a protocol message, thereby causing processes competing for locks on the resource(s) managed by the participant to have to wait for the exclusive locks held by the coordinator to be released.

FIG. 1A conceptually illustrates conventional intra-enterprise distributed transaction processing using a Two-Phase Commit (2PC) protocol. In this simplified example, an enterprise 100 that sells products maintains an accounting database 130 and an inventory database 140. The inventory database 140 may maintain information regarding product availability, such as the number and kind of products that are currently on hand. The accounting database 130 may maintain information regarding transaction details, such as the purchase price for each item of inventory and the date and time of the sale. Importantly, in this example, a sales transaction 110 is an atomic transaction that must update both databases 130 and 140 or neither. Consequently, before the sales transaction 110 can be concluded, the sales transaction 110 must first obtain locks via two-phase commit resource manager(s) 120 on both databases 130 and 140.

While the 2PC protocol is satisfactory for intra-enterprise transactions where the transactions are relatively short and the transaction initiators are trusted, extending this protocol outside of the enterprise firewall with Transaction Internet Protocol (TIP) or the like is expected to create problems. Notably, from the time a 2PC resource manager (e.g., a database manager) is enlisted in a transaction by initiating a change to the resource under it control (e.g., the database controlled by the database manager), to the time the final commit or abort is made, the control of the resource is ceded to the 2PC coordinator, i.e., the 2PC coordinator holds an exclusive lock on the resource. This precludes the resource from being available to other transactions. This is unacceptable in inter-enterprise scenarios for several reasons. First, someone could use the 2PC protocol as part of a Denial-of-Service attack by holding a lock to the enterprise's resources indefinitely. Second, businesses are unlikely to allow 2PC coordinators in other businesses to control their resources since interactions between enterprises have a significantly longer duration compared to intra-enterprise transactions. Finally, many more inter-enterprise transactions are likely to be aborted compared to intra-enterprise transactions as a result of the increased uncertainty associated with inter-enterprise transactions. For example, in the context of a travel related transaction, a consumer might first buy an airline ticket as a part of the transaction. Subsequently, when the consumer tries to rent a car as a part of the same transaction, the consumer may realize that an earlier quoted rate is no longer valid. This could force the consumer to abort the entire transaction, thus canceling the airline ticket purchase. As will be described in more detail below, the airline may lose many other sales during this process because the consumer's transaction was holding an exclusive lock on the airline's ticketing database(s).

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1A conceptually illustrates conventional intra-enterprise transaction processing using a Two-Phase Commit (2PC) protocol.

FIG. 1B conceptually illustrates inter-enterprise transaction processing using the Two-Phase Commit (2PC) protocol.

FIG. 2 conceptually illustrates distributed transaction processing using a novel e-Business Distributed Transaction Processing (e-DTP) protocol and architecture according to one embodiment of the present invention.

FIGS. 3A and 3B depict a scenario that illustrates various advantages of the e-Business Distributed Transaction Processing (e-DTP) protocol over the Two-Phase Commit protocol in connection with inter-enterprise transactions.

FIG. 4 is a computer system in which various features of the present invention may be implemented.

FIG. 5 is a high-level block diagram of an enterprise implementing an e-Business Distributed Transaction Processing (e-DTP) transaction manager according to one embodiment of the present invention.

FIG. 6 is a simplified, high-level flow diagram illustrating distributed transaction processing according to one embodiment of the present invention.

FIG. 7 is a high-level state diagram illustrating states and transitions according to one embodiment of the present invention.

### DETAILED DESCRIPTION OF THE INVENTION

Apparatus and methods are described for a tentative-hold-based protocol for distributed transaction processing. Broadly stated, embodiments of the present invention seek to provide reliable transaction support across enterprises. According to one embodiment, a tentative-hold-based protocol provides the ability to treat multiple transactions relating to multiple suppliers (e.g., service providers or product vendors) as a single atomic transaction. For example, a plane flight, a hotel reservation, and a car rental reservation may be treated as a single atomic travel reservation transaction. In this example, tentative holds (e.g., non-mutually exclusive, weak locks on availability and price of an item) may be placed on the three items. Then, when the user is satisfied with the entire travel package, the user may commit to the single atomic travel reservation transaction, thereby lessening the effort required by the user in terms of interactions with disparate service providers. Tentative holds also benefit suppliers since inventory is not tied up with exclusive locks for long periods of time. Advantageously, a tentative-hold-based protocol allows enterprises to cede control of their resources for only a short duration while accommodating the intrinsic long-duration of typical inter-enterprise transactions.

According to one embodiment, the tentative-hold-based protocol allows resource managers participating in distributed transactions to make weaker commitments than that currently required by use of the 2PC protocol alone, thereby enabling long-duration transactions to be accommodated. Rather than assuring that the requested state change will be held or rolled back, the resource managers may simply agree to notify the transaction coordinator if the requested state change will no longer be possible. The tentative-hold-based protocol may be divided into two stages, a tentative hold stage and a transaction completion stage. In one embodiment, the transaction completion stage may be implemented by conventional transaction processing means, such as the 2PC protocol using Microsoft Transaction Service (MTS), Customer Information Control System (CICS) of International Business Machines (IBM), Tuxedo of BEA Systems, Inc., or the like. Alternatively, the transaction completion stage may comprise manual means (e.g., phone, fax, email, etc.).

According to another embodiment, the tentative-hold-based protocol may be implemented as an incremental layer above the 2PC protocol, thereby extending the 2PC protocol to accommodate the specific needs of inter-enterprise transactions. That is, the 2PC protocol need not be cast aside as contemplated with the use of compensating transactions in connection with inter-enterprise transactions. Rather, a new distributed transaction coordination entity enables 2PC coordination among a plurality of resources providing discrete services or items of an atomic distributed transaction. In operation, the new distributed transaction coordination entity receives information regarding an atomic distributed transaction that represents an aggregation of multiple discrete transactions for individual resource items that span a plurality of network resources. The new distributed transaction coordination entity places a tentative hold on each of the plurality of individual resource items by causing a tentative hold record to be created and associated with each of the plurality of discrete transactions. Importantly, the tentative holds operate in a non-mutually exclusive manner, thereby allowing the same resource item to be tentatively held by more than one transaction. Finally, after receiving a confirmation regarding the atomic distributed transaction from the user initiating the transaction and after successfully gaining tentative holds on each of the discrete transactions, the new distributed transaction coordination entity attempts to direct the completion of the atomic distributed transaction by conventional means (e.g., by employing the 2PC protocol, Microsoft Transaction Service (MTS), IBM's CICS, BEA Tuxedo, or other existing transaction completion mechanism). Advantageously, in this manner, inter-enterprise transactions become feasible as businesses need only cede control of their resources for a short duration (during the transaction completion phase) while accommodating the intrinsic long-duration of such transactions.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection). Accordingly, a carrier wave or other propagation medium shall be regarded as comprising a machine-readable medium for the purpose of the present specification.

While, for convenience, embodiments of the present invention are described with reference to inter-business distributed transaction processing that span multiple businesses, the present invention is equally applicable to various other types of distributed transactions. For example, distributed transactions that span multiple network resources (e.g., databases or information systems of a distributed system) within a business are also likely to benefit from the novel protocol described herein.

Additionally, embodiments of the present invention are described in the context of receiving an aggregated transaction and information identifying the appropriate service providers/resources. However, the present invention is equally applicable to the provision of transaction services for dynamically constructed transactions. Furthermore, for sake of brevity, embodiments of the present invention are described with reference to the use of a specific conventional transaction processing protocol (i.e., the Two-Phase Commit (2PC) protocol) for the transaction completion phase of the tentative-hold-based protocol. Nevertheless, the present invention is equally applicable to various other transaction processing protocols and may be used to supplement or replace various existing transaction processing mechanisms to ensure ACID properties are provided for distributed transactions.

Terminology

Brief definitions of terms used throughout this application are given below.

“Two-Phase Commit” generally refers to a technology employed by transaction processing systems to automatically control and monitor commit and/or rollback activities for transactions in a distributed system. Such distributed transactions may require modification to many different distributed resources (e.g., databases or other information systems residing on a network). Two-phase commits are done to maintain data integrity and accuracy within the distributed resources through synchronized locking of all pieces of a transaction. An important characteristic of two-phase commit technology is that it is designed to ensure that either all the distributed resources involved in a transaction are updated or none of them, thereby keeping the distributed resources synchronized. Additionally, the two-phase commit strategy enables the distributed resources to be returned to their pre-transaction state if the transaction is aborted or interrupted by an error condition.

In the context of the described embodiment, a “transaction” generally refers to an atomic action or unit of work, such as a computation, that changes or reads the state of one or more data objects and appears to take place indivisibly. Without loss of generality, a transaction may comprise one or more Structured Query Language (SQL) statements, one or more remote procedure calls, one or more eXtensible Markup Language (XML) statements, one or more application (or cross-application) operations of commands, one or more Object Query Language (OQL) statements, one or more synchronous message invocations (Java JMS, or CORBA CMS), one or more Common Object Request Broker (CORBA) procedure calls or messages, one or more Secure Socket Layer (SSL) connection message sequences, one or more Transmission Control Protocol (TCP)/Internet Protocol (IP) socket message sequences, or the like.

A “distributed transaction” generally refers to a transaction that involves two or more distributed resources, such as databases or information systems of a distributed system. For example, a distributed transaction may update data residing on two or more distinct nodes of a distributed database.

An “e-business distributed transaction” generally refers to a distributed transaction that spans two or more enterprises.

Extension of the Two-Phase Commit Protocol to Inter-Enterprise Transactions

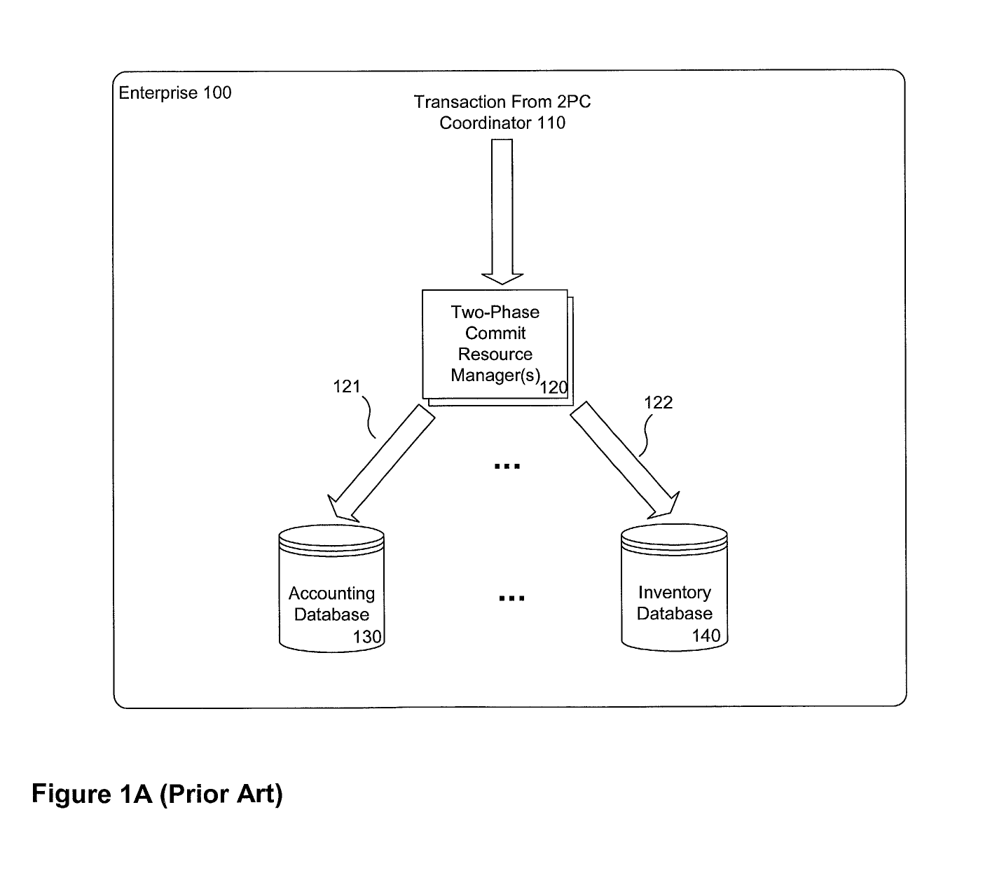

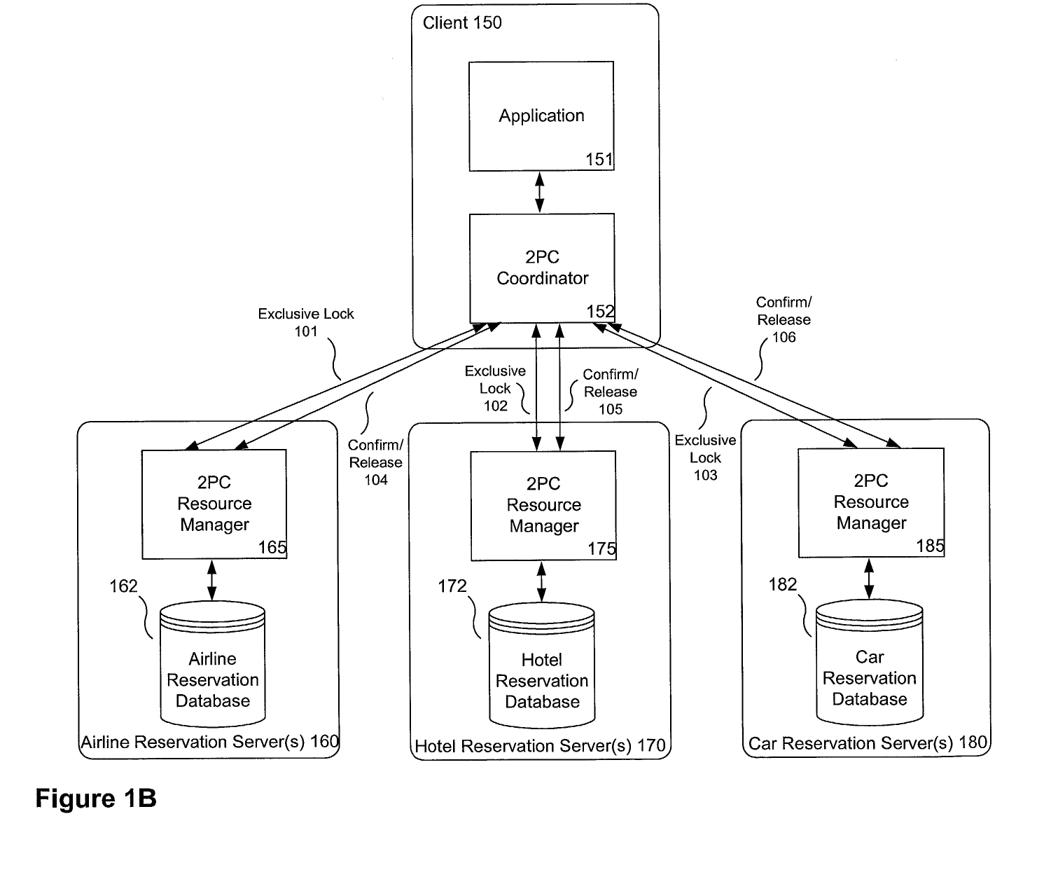

FIG. 1B conceptually illustrates inter-enterprise transaction processing using the Two-Phase Commit (2PC) protocol. As described above, extending the 2PC protocol outside of the enterprise firewall is expected to have several insurmountable drawbacks. These drawbacks are better understood when presented in the context of a concrete example, such as that depicted in FIG. 1B. In this example, a user (not shown) seeks to make a travel reservation via client 150. As is typical in such a scenario, the user wants to be sure that either all the components of the reservation (e.g., an airline reservation, a hotel reservation, and a rental car reservation) are made or none are made. The three discrete components of the travel reservation transaction are handled by three separate enterprises. The airline reservation is accomplished by interacting with airline reservation server(s) 160, hotel reservation server(s) 170 process requests for hotel reservations, and car rental reservations must be made with the car reservation server(s) 180. In response to a user request for travel reservation options, application 151 presents an aggregated travel reservation transaction to a 2PC coordinator 152. The 2PC coordinator then queries the databases necessary for fulfilling the travel reservation 162, 172, and 182. Assuming one or more reservations meeting the user's needs are available in each of the databases 162, 172, and 182, the 2PC coordinator then initiates the prepare phase by requesting exclusive locks 101-103 on one or more airline seats in the airline reservation database 162, one or more hotel rooms in the hotel reservation database 172, and one or more rental cars from the car reservation database 182, respectively, from their associated 2PC resource managers 165, 175, and 185. Assuming the exclusive lock requests 101-103 are granted, the 2PC coordinator 152 informs the application 151 and the application 151 may present the various travel package combinations that meet the user's needs. At this point, the user evaluates his/her options from among the available combinations and potentially changes his/her criteria. All the while, the user's travel reservation transaction is holding exclusive locks to the databases 162, 172, and 182, thereby precluding other consumers from making reservations. Finally, when the user is satisfied with a particular combination of reservations, he/she books (confirms) a particular travel reservation transaction by interacting with the application 151. In response, the application 151 provides information identifying the desired travel reservation transaction to the 2PC coordinator 152. After receiving information regarding the desired travel reservation transaction from the application 151, the 2PC coordinator 152 initiates the confirmation phase of the 2PC protocol, by requesting the 2PC resource managers 165, 175, and 185 to commit their portion of the transaction. At this point, the user's travel reservation transaction is completed and the exclusive locks 101-103 are released. Only now can another interested party acquire a lock on one of the databases 162, 172, and 182 to begin their travel reservation process.

As will now be appreciated, the inherent long-duration of inter-enterprise transactions combined with the potential for misuse of locks, and the increased uncertainty associated with inter-enterprise transactions make the use of the 2PC protocol alone impractical for conducting inter-enterprise transactions.

e-Business Distributed Transaction Processing (e-DTP) Protocol Overview

The e-Business Distributed Transaction Processing™ (e-DTP™) architecture and protocol described herein seek to resolve limitations associated with extending current transaction processing protocols to inter-enterprise transactions, thereby facilitating the adoption of inter-enterprise transactions (e-Business Distributed Transaction Processing and e-DTP are trademarks or registered trademarks of Intel Corporation of Santa Clara, Calif.).

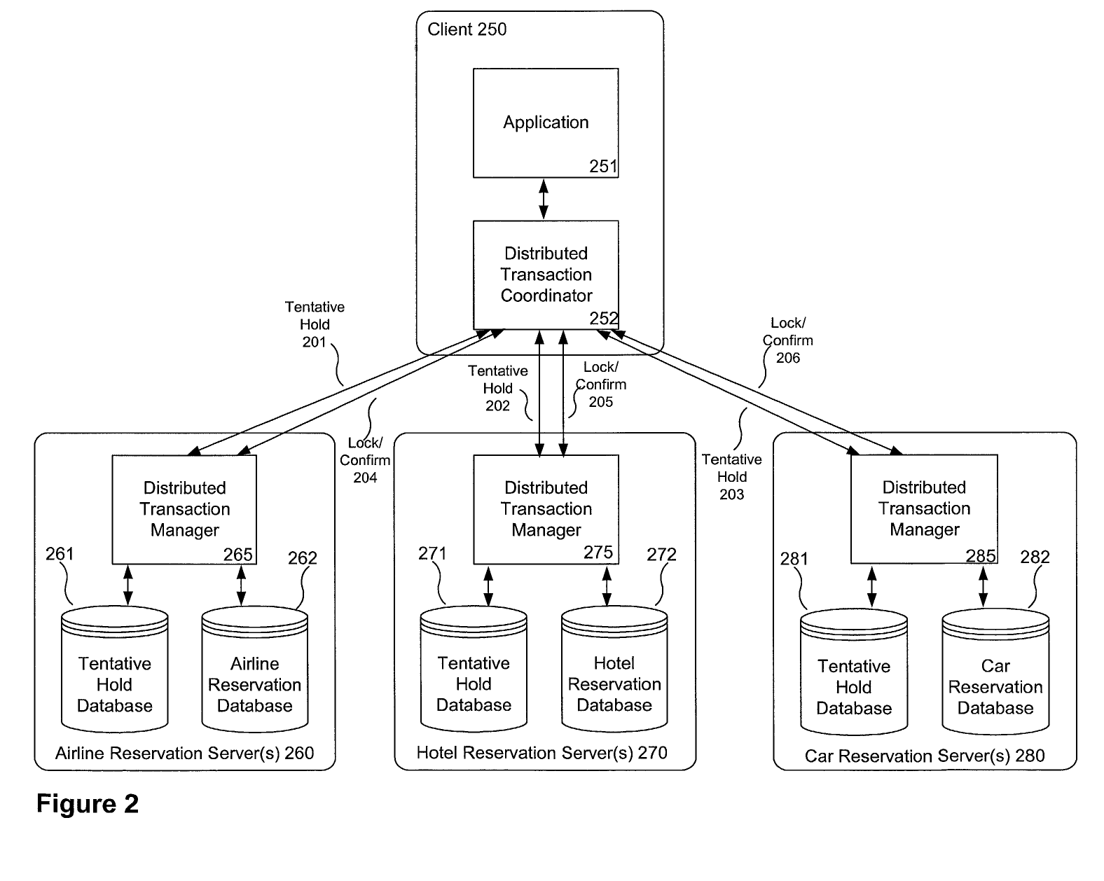

FIG. 2 is a simplified block diagram that conceptually illustrates distributed transaction processing using a novel e-Business Distributed Transaction Processing (e-DTP) protocol and architecture according to one embodiment of the present invention. Briefly, by way of a new tentative-hold-based distributed transaction protocol, e-DTP provides the ability to treat many discrete requests as a single atomic transaction. An important distinction of this tentative-hold-based protocol over the 2PC scenarios discussed herein is that the protocol enables all the discrete components of an atomic distributed transaction to be tentatively held prior to establishment of exclusive locks on the resource items, thereby allowing enterprises to cede control of their resources for only a short duration while accommodating the intrinsic long-duration of typical inter-enterprise transactions.

In this example, a user (not shown) seeks to make a travel reservation via client 250. As above, the user wants to be sure that either all the components of the reservation (e.g., an airline reservation, a hotel reservation, and a rental car reservation) are made or none are made. The three discrete components of the travel reservation transaction are handled by three separate enterprises. The airline reservation is accomplished by interacting with airline reservation server(s) 260, hotel reservation server(s) 270 process requests for hotel reservations, and car rental reservations must be made with the car reservation server(s) 280.

In response to a user request for travel reservation options, application 251 presents an aggregated travel reservation transaction to a distributed transaction coordinator 252. The distributed transaction coordinator then queries the databases necessary for fulfilling the travel reservation 262, 272, and 282. Assuming one or more reservations meeting the user's needs are available in each of the databases 262, 272, and 282, the distributed transaction coordinator then initiates a tentative hold phase of the tentative-hold-based protocol by sending requests for tentative holds 201-203 to the distributed transaction managers 265, 275, and 285, respectively.

Assuming a reservation for the target resource items (e.g., airline seat, hotel room, rental car) could be fulfilled at the time of the requests, each of the distributed transaction managers 265, 275, and 285 insert a tentative hold record into a data store (e.g., the tentative hold databases 261, 271, and 281) to record the existence of the tentative hold and associate the transaction with the target resource. According to one embodiment, the tentative hold record may include call back information (such as a pointer to a handle provided by application 252, a logical or physical network address, information identifying a port and socket, and/or other address information) to provide a return communication path back to either the distributed transaction coordinator 252 or the application 251. Importantly, the tentative holds are not mutually exclusive. That is, the distributed transaction managers 265, 275, and 285 will accept more than one request for a tentative hold for the same resource and insert a tentative hold record for each tentative hold request into the data store.

According to one embodiment, the grant of a tentative hold is a relatively weak commitment compared to the strong commitment provided by an exclusive lock. Rather than assuring that the requested state change will be held, the distributed transaction managers 265, 275, and 285 merely agree to notify the distributed transaction coordinator 252 or the application 251 if the requested state change will no longer be possible. For example, as discussed in more detail below, if a transaction acquires an exclusive lock on a resource item and subsequently consumes the resource item, then the applications or distributed transaction coordinators associated with competing transactions having tentative holds on that resource item may be notified by using the call back information to determine appropriate return communication paths.

At any rate, after acquiring tentative holds on all the discrete components of the travel reservation transaction and after the user has indicated he/she is ready to commit to making the travel reservation, the distributed transaction coordinator 252 initiates a transaction completion phase which may employ one or more conventional transaction completion mechanisms, such as the 2PC protocol, Microsoft Transaction Service (MTS), IBM's CICS, BEA Tuxedo, or other existing transaction completion mechanisms. Assuming transaction completion using the 2PC protocol, the distributed transaction coordinator 252 requests exclusive locks 204-206 for appropriate items in the airline reservation database 262, the hotel reservation database 272, and the car reservation database 282, respectively. Assuming the exclusive locks 204-206 are all granted, then the distributed transaction coordinator requests that the distributed transaction managers 265, 275, and 285 commit their portion of the transaction. At this point, the user's travel reservation transaction is completed and the exclusive locks 101-103 are released. As a result, exclusive locks are held for only a short period of time as compared to the use of the 2PC protocol alone for an inter-enterprise transaction.

While in the embodiment depicted the distributed transaction processing coordinator 252 is shown as a single entity, it is contemplated that the distributed processing coordinator 252 may actually comprise multiple physical and/or logical devices connected in a distributed architecture; and the various functions performed may actually be distributed among multiple clients and/or servers. For example, the distributed transaction coordinator 252 may be a group of one or more distributed software processes running on one or more networked computer systems. According to one embodiment, the distributed transaction coordinator 252 may include an e-DTP coordinator process for handling the client-side of the tentative hold phase and a 2PC coordinator process for handling the client-side of the completion phase.

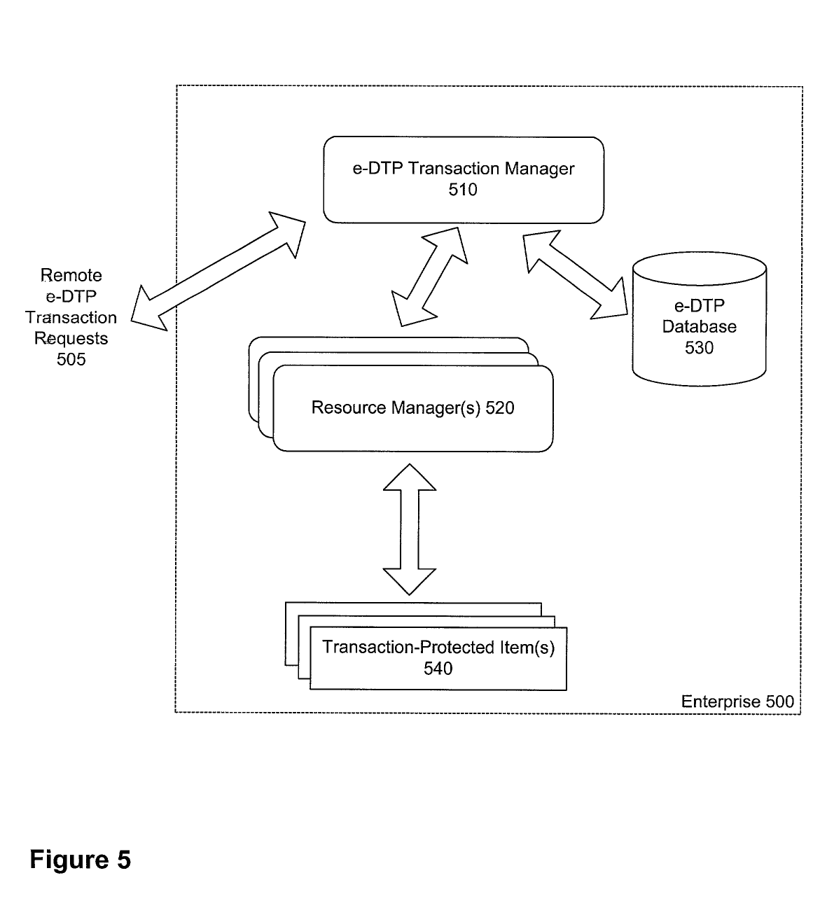

Similarly, the distributed transaction managers 265, 275, and 285 may each be implemented as a group of one or more distributed software processes running on one or more networked computer systems. According to one embodiment discussed further below with respect to FIG. 5, the distributed transaction manager 265, 275, and 285 may each include one or more e-DTP transaction managers for handling the server-side of the tentative hold phase and one or more 2PC resource managers for handling the server-side of the completion phase.

While in the embodiment depicted the user (customer) interacts directly with disparate enterprises via application 251 and distributed transaction coordinator 252, it is contemplated that various other architectural models may be employed. For example, according to one embodiment, the user may interact with a central clearinghouse type of service, such as a market exchange, or travel service, that itself is tied into the disparate enterprises.

Distributed Transaction Processing Scenarios

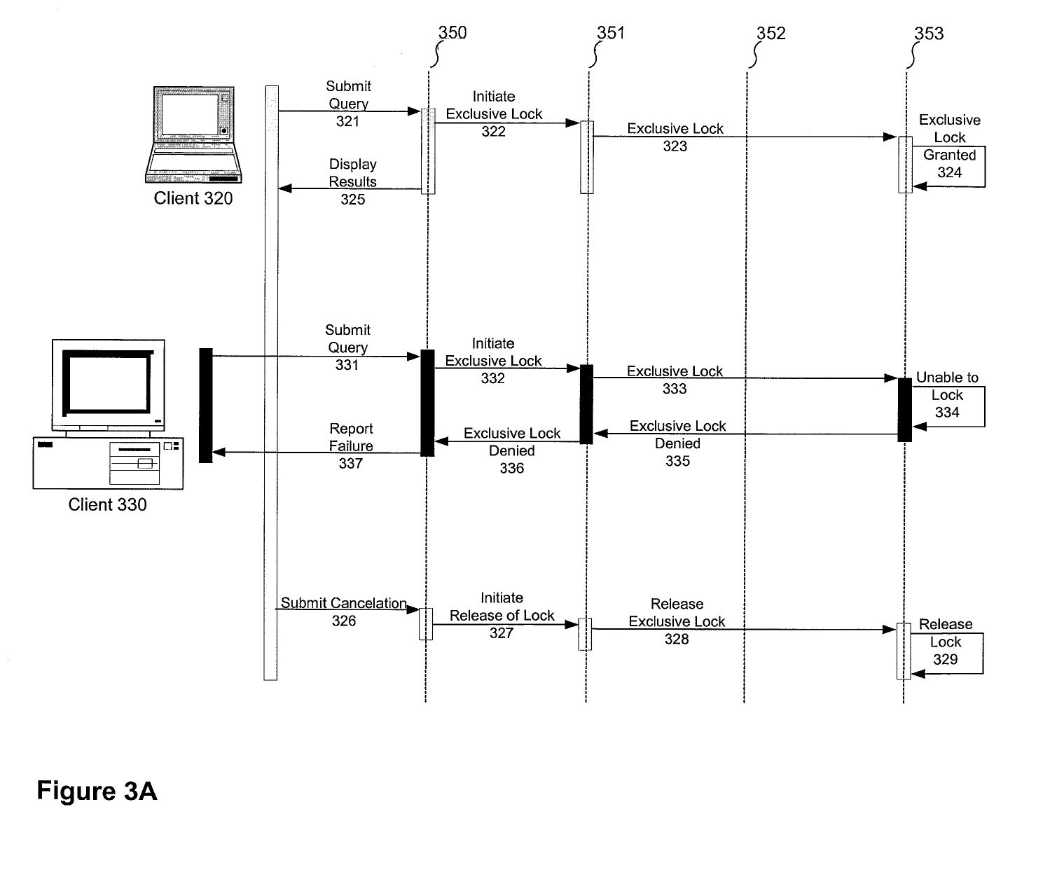

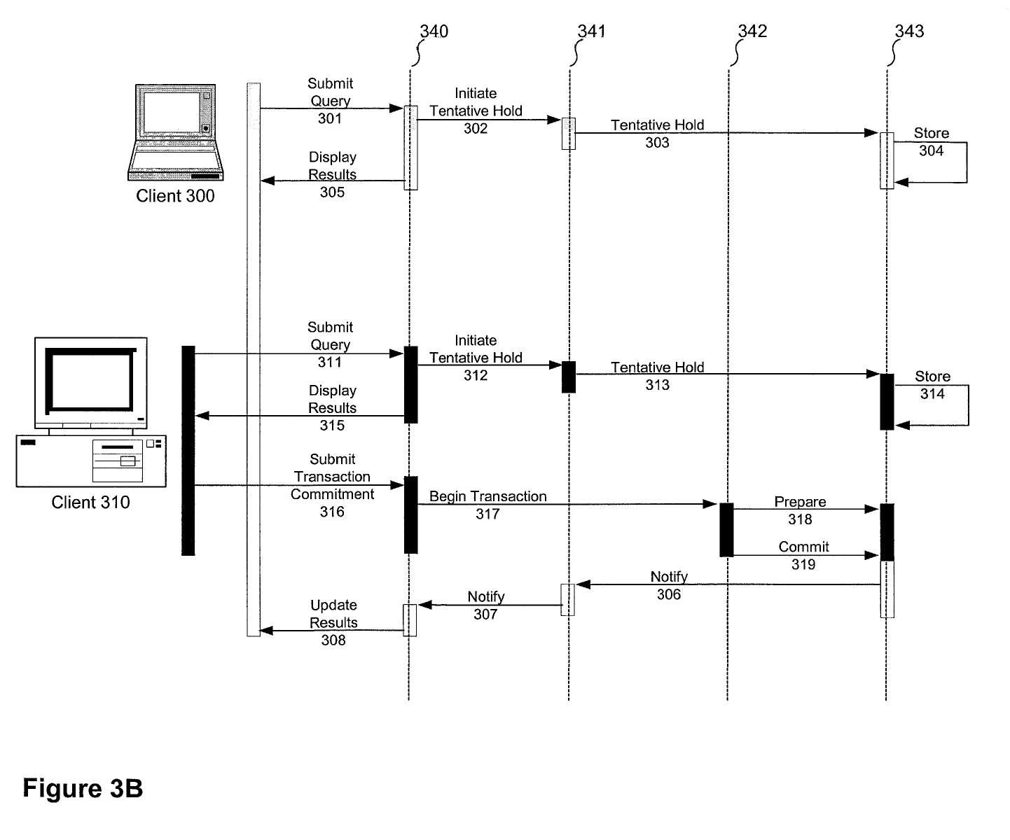

FIGS. 3A and 3B depict a scenario that illustrates various advantages of the e-Business Distributed Transaction Processing (e-DTP) protocol over the Two-Phase Commit (2PC) protocol in connection with inter-enterprise transactions. In FIG. 3A, a 2PC protocol is employed. A transaction timeline for a transaction initiated by client 320 is depicted in gray and a transaction timeline for a transaction initiated by client 330 is depicted in black. In this scenario, client 320 is the first to obtain an exclusive lock to a particular resource or resource item and is slow to make a decision. Consequently, when client 330 tries to obtain an exclusive lock, it is denied. As a result, a potential sale may be lost since client 330 is turned away and ultimately client 320 cancels its transaction request.

In contrast, FIG. 3B illustrates a tentative-hold-based approach and the non-mutually exclusive nature of tentative holds. Again, two transaction timelines are depicted. The transaction initiated by client 300 is colored gray and the transaction initiated by client 310 is colored black. In this scenario, client 300 is the first to obtain a tentative hold on a resource or resource item. However, because the tentative hold acquired by client 300 is not exclusive, client 310 is also able to subsequently obtain a tentative hold on the same resource or resource item. Additionally, because client 310 is the first willing to commit to the transaction, it is able to complete the transaction without any interference from the prior tentative hold that was obtained by client 300.

Computer System Overview

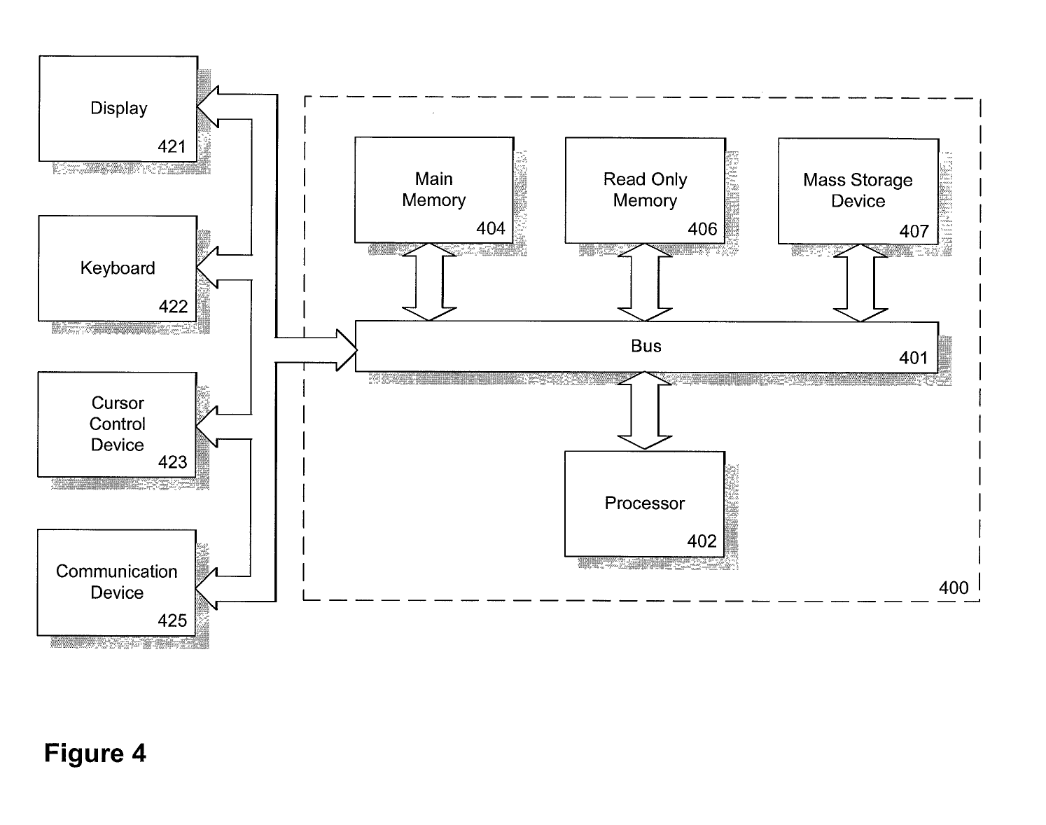

An exemplary machine in the form of a computer system 400, representing an exemplary client system or enterprise server system, in which features of the present invention may be implemented will now be described with reference to FIG. 4. In this simplified example, the computer system 400 comprises a bus or other communication means 401 for communicating information, and a processing means such as one or more processors 402 coupled with bus 401 for processing information. Computer system 400 further comprises a random access memory (RAM) or other dynamic storage device 404 (referred to as main memory), coupled to bus 401 for storing information and instructions to be executed by processor(s) 402. Main memory 404 also may be used for storing temporary variables or other intermediate information during execution of instructions by processor(s) 402. Computer system 400 also comprises a read only memory (ROM) and/or other static storage device 406 coupled to bus 401 for storing static information and instructions for processor 402. Optionally, a data storage device (not shown), such as a magnetic disk or optical disc and its corresponding drive, may also be coupled to bus 401 for storing information and instructions.

One or more communication ports 425 may also be coupled to bus 401 for allowing various local or remote clients or servers to exchange information with the computer system 400 by way of a Local Area Network (LAN), Wide Area Network (WAN), Metropolitan Area Network (MAN), the Internet, or the public switched telephone network (PSTN), for example. The communication ports 425 may include various combinations of well-known interfaces, such as one or more modems to provide dial up capability, one or more 10/100 Ethernet ports, one or more Gigabit Ethernet ports (fiber and/or copper), or other well-known interfaces, such as Asynchronous Transfer Mode (ATM) ports and other interfaces commonly used in existing LAN, WAN, MAN network environments. In any event, in this manner, the computer system 400 may be coupled to a number of other clients and/or servers via a conventional network infrastructure, such as a company's Intranet and/or the Internet, for example.

Enterprise-Level Distributed Transaction Processing Components

FIG. 5 is a high-level block diagram of an enterprise implementing an e-Business Distributed Transaction Processing (e-DTP) transaction manager according to one embodiment of the present invention. In this example, the software architecture of an e-DTP enabled enterprise 500 includes an e-DTP transaction manager 510, an e-DTP database 530, and resource managers 520 corresponding to each transaction-protected item 540.

The e-DTP transaction manager 510 is the coordinator for transactions. It corresponds roughly to classic Two Phase Commit (2PC) transaction managers, such as the Microsoft Transaction Services Transaction Manager, but extends the functionality to provide e-DTP capabilities as described herein.

The e-DTP database 530 contains information required by the e-DTP transaction manager 510 for managing remote transactions. This stored information may include:

1. Current transaction states (e.g., information identifying what resources currently have tentative holds);

2. Logs of all transaction information for tracking and recovery purposes;

3. Customer-validation information;

4. Enterprise-specific business rules, if any, dealing with how the e-DTP transaction manager 510 should manage transaction requests (e.g., certain identified customers may have greater weight when assigning hold expiration times).

The resource manager(s) 520 are similar to the resource managers in classic 2PC systems in that they provide a front-end for managing transaction-protected resources 540. Transaction-protected resources may include, for example, airline flight seats, hotel room availability, etc.

At any rate, when managing an e-DTP transaction request, the e-DTP transaction manager 510 may maintain state information tying that request to some resource managed by a local resource manager 520. An exemplary state diagram providing a high-level view of these states and their transitions is described below.

In an alternative embodiment, enterprises need not individually be e-DTP enabled. Rather, intermediate server systems may provide the functionality of the e-DTP transaction manager 510 and the tentative hold tracking functionality of the e-DTP database 530 on behalf of non-e-DTP enabled enterprises.

Distributed Transaction Processing

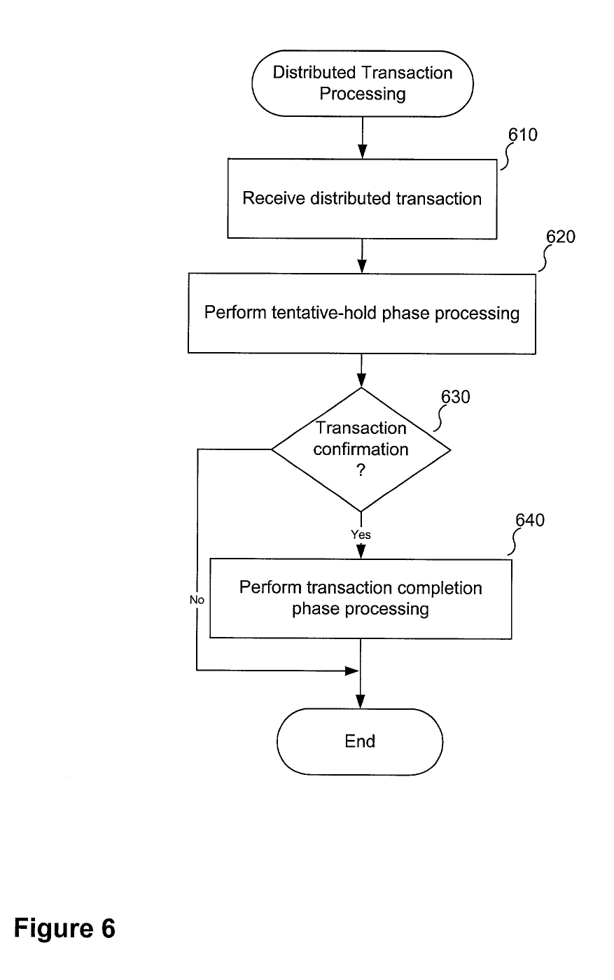

FIG. 6 is a simplified, high-level flow diagram illustrating distributed transaction processing according to one embodiment of the present invention. In one embodiment, the processing blocks described below may be performed under the control of a programmed processor, such as processor 402. However, in alternative embodiments, the processing blocks may be fully or partially implemented by any programmable or hard-coded logic, such as Field Programmable Gate Arrays (FPGAs), TTL logic, or Application Specific Integrated Circuits (ASICs), for example.

At processing block 610, a distributed transaction is received by the distributed transaction coordinator 252. As mentioned above, the distributed transaction represents an aggregation of a number of discrete transactions for resource items (e.g., products or services, such as airline seats, hotel rooms, and rental cars) that span multiple network resources. The distributed transaction may include information identifying the network resources, such as Uniform Resource Locators (URLs) or logical or physical network addresses), or the choice of appropriate network resources may be left up to the distributed transaction coordinator 252. The multiple network resources may be nodes of an intra-enterprise distributed database system or information systems associated with web sites of various enterprises, for example.

At processing block 620, the distributed transaction coordinator 252 initiates the first phase of the tentative-hold-based protocol, tentative hold phase processing. Upon successful completion of the tentative hold phase, the distributed transaction has acquired a tentative hold on each of the resource items associated with the distributed transaction. This may be accomplished, for example, by the distributed transaction coordinator 252 requesting that a non-mutually exclusive hold be granted by the distributed transaction manager for each of the resource items involved in the distributed transaction. Assuming all the tentative holds are obtained, processing continues with decision block 630 At decision block 630, the distributed transaction coordinator 252 waits for confirmation of the distributed transaction. In the embodiment depicted, if the distributed transaction is not confirmed within the timeout intervals associated with the various tentative holds, then the tentative holds may be lost and the distributed transaction would potentially have to be resubmitted beginning at processing block 610. However, assuming none of the timeout intervals have expired, responsive to receipt of a confirmation to complete the distributed transaction, control flows to processing block 640.

At processing block 640, the distributed transaction coordinator 252 initiates the second phase of the tentative-hold-based protocol, transaction completion phase processing. Upon successful completion of the transaction completion phase, the distributed transaction has been fulfilled. That is, all of the resource items involved in the distributed transaction have been successfully acquired. According to one embodiment, the transaction completion phase may involve the use of one or more conventional transaction processing mechanisms, such as the 2PC protocol, Microsoft Transaction Service (MTS), Customer Information Control System (CICS) of International Business Machines (IBM), Tuxedo of BEA Systems, Inc., or the like. Alternatively, the transaction completion phase may comprise manual means (e.g., phone, fax, email, etc.). Further details regarding transaction states, transitions among the states, and the various triggering conditions for the transitions are described below.

Exemplary State Diagram

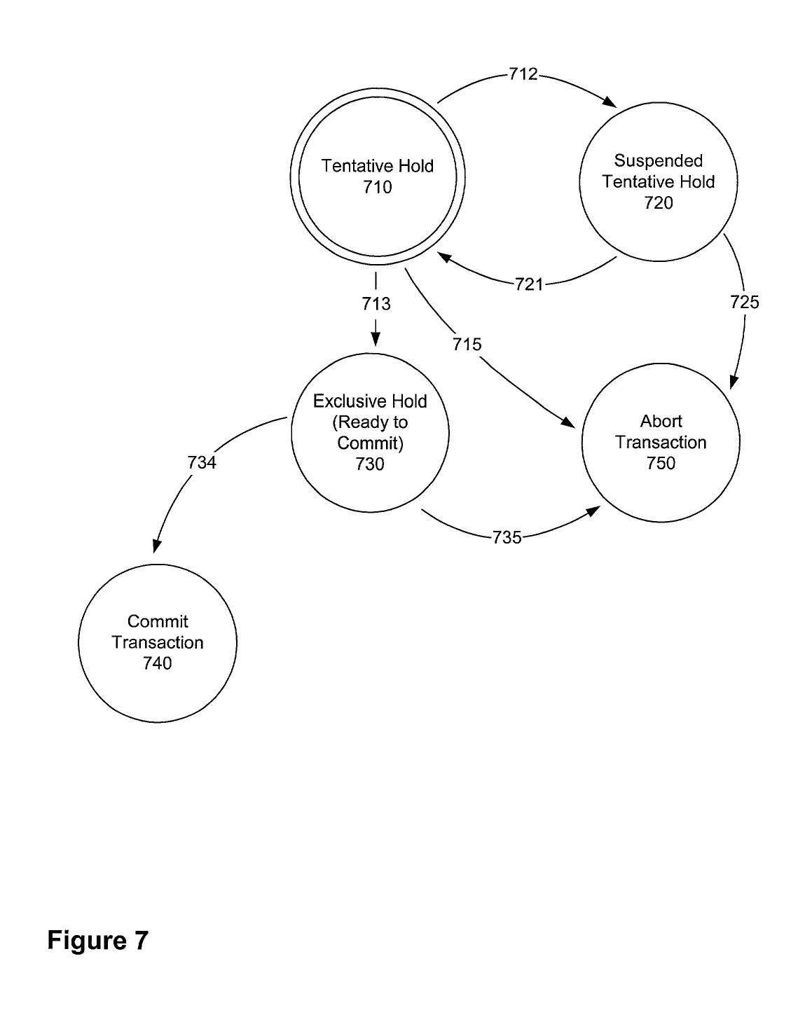

FIG. 7 is a high-level state diagram illustrating states and transitions according to one embodiment of the present invention. As mentioned above, when managing an e-DTP transaction request, the e-DTP transaction manager 510 may maintain state information tying that request to some resource managed by a local resource manager 520. In this example, the following states are employed: a tentative hold state 710, a suspended tentative hold state 720, an exclusive hold state 730, a commit transaction state 740, and an abort transaction state 750.

When a transaction request is received by the e-DTP transaction manager, the transaction is initially placed in the tentative hold state 710 and the requestor is granted a non-exclusive hold on the resource if that resource is currently available (e.g., airline seat 4C on flight 2001). Recall, since this is a non-exclusive hold, it is possible that other clients have also requested and been granted a hold on this resource. In the case of an inter-enterprise transaction, the transaction request may remain in this state for some extended period while the client is placing tentative holds across other e-DTP enabled enterprises.

According to the embodiment depicted, there are three possible transitions from the tentative hold state 710. The transaction may advance to the exclusive hold state 730, the suspended tentative hold state 720, or the abort transaction state 750 for the target resource. According to one embodiment, the e-DTP transaction manager 510 may send notifications to clients when state changes occur. At any rate, a transition 713 to the exclusive hold state 730 is triggered by receipt of an indication from the transaction originator (e.g., the client) that there is a desire to continue the transaction.

A transition 712 to the suspended tentative hold state 720 from the tentative hold state 710 is caused by a competing transaction (i.e., a transaction that also had a tentative hold on the same resource) advancing to the exclusive hold state 730. Consequently, if multiple clients have a tentative hold on a given resource and then one client acquires an exclusive hold (showing possible intent to commit), all other clients having a tentative hold on the resource are suspended while the outcome of the transaction is in progress.

A transition 715 to the abort transaction state 750 may result from either a timeout of a tentative hold or a cancellation of the tentative hold. A timeout occurs when the e-DTP transaction manager 510 determines that the tentative hold is stale and should be removed. According to one embodiment, timeout limits for tentative holds may be stored in the e-DTP database 530 and may differ based upon information regarding the customer or related business rules. Although not required by the e-DTP protocol due to the existence of a timeout mechanism, a friendly client may communicate a cancellation of its tentative hold.

As mentioned above, the suspended tentative hold state 720 represents a state in which all transactions are placed that had tentative holds once a competing transaction has advanced to the exclusive hold state 730. As a result, if there are multiple clients with a tentative hold on a resource and one is attempting to move forward with their transaction, all other competing transaction states will be moved to the suspended tentative hold state 720 until the outcome of the transaction that is moving forward is known. If for any reason that transaction aborts, all suspended holds transition 721 back to the tentative hold state 710. According to the embodiment depicted, there are two possible transitions from this state: a transition 721 that returns the transaction to the tentative hold state 710, and a transition 725 that places the transaction in the abort transaction state 750. The transition 721 returning the transaction to the tentative hold state 720 is triggered by a competitive transaction being aborted. The transition 725 to the abort transaction state 750 is a result of either a competitive transaction being committed or the client aborting the current transaction.

The exclusive hold state 730 represents a state in which the client has requested to commence committing the transaction. Typically, the client requests to proceed to this state after having gathered tentative holds on all the resources desired and after the user has indicated a desire to complete the transaction. For example, a client might be requesting not only seat 4C from one enterprise, but also a hotel room reservation for that evening from another enterprise managing hotels. Unlike the tentative hold state 710, the exclusive hold state is not intended to be long-lived. In one embodiment, a timeout mechanism similar to that described above with respect to the tentative hold state 710 may be associated with this state. Importantly, one and only one client (transaction) may have a resource in the exclusive hold state 730. As discussed above, if there were any competing clients that had a tentative hold, they would have been moved to the suspended tentative hold state 720, pending the results of this transaction attempt. According to the embodiment depicted, there are two possible exits from this state: a transition 734 to the commit transaction state 740 and a transition to the abort transaction state 750. The transition 734 to the commit transaction state 740 occurs when the client has responded within the timeout period requesting that the transaction be completed. Recall that at this point the e-DTP transaction manager 510 aborts any existing competing transactions having tentative holds on the resource. The transition 735 to the abort transaction state 750 occurs in response to either the client's failure to respond within the timeout period or the client requesting cancellation of the transaction.

The abort transaction state 750 represents a final state for a transaction that has been cancelled as a result of a timeout or an explicit cancellation by the client.

The commit transaction state 740 represents a final state for a transaction that has been completed successfully. In the airline seat example, the client would now have the requested seat assignment.

It is important that resources are not capable of being locked indefinitely by a transaction that will never be committed. For this reason, there are timeouts associated with the tentative hold state 710 and the exclusive hold state 730. Depending upon the context of the transaction, a valid tentative hold timeout period might be measured in hours or days, thereby permitting clients adequate time to build their desired transaction. In the exemplary architecture of FIG. 5, the only resources tied up with a tentative hold are the e-DTP database (which stores the transaction state) and the e-DTP transaction manager 510 (which monitors the timeout). Also, since all clients are not necessarily “good” clients, it is prudent to provide periodic opportunities for the e-DTP transaction manager 510 to perform cleanup since the Internet client may place a tentative hold then disappear forever.

The timeout on the exclusive hold is for the protection of the owner of the resource. It is possible that a client could move into the exclusive hold state 730 and then never communicate again. Without the timeout, the e-DTP transaction manager 510 would have no way of voiding the transaction; the resource would be locked for some indeterminate period (awaiting some outside intervention to manually free up the resource), and any other potential customer would not have access to the resource. Determination of the timeout period for exclusive holds is dependent on the individual enterprise and any business rules it has implemented. According to one embodiment, targeted customers (e.g., preferred customers) may be provided with more or less time.

At this point, it is appropriate to discuss the resource managers 520 and how the e-DTP transaction manager 510 interacts with them. As noted previously, a resource manager 520 is the point of contact for accessing items that are of concern to the transaction. Often the resource manager 520 is sitting in front of some database containing information or resources that are accessible within the transactions.

In a 2PC system, there is some client sufficiently privileged to create a transaction request through a 2PC transaction manager. Any resource managers associated with the request are enlisted and the required resources are locked (prepare phase of the 2PC protocol). Once all interested parties have responded positively to the first phase, the transaction can commit (e.g., the 2PC transaction manager notifies the appropriate resource managers to complete the transaction). Note that the client is not in control of the transaction in a 2PC system. The client merely makes a request and submits it to the 2PC transaction manager, which watches the voting of the interested parties (either Commit or Abort), then instructs the resource managers appropriately. It is important to note that when a resource manager accepts the first phase, the requested resource is locked until the resource manager is notified by the 2PC transaction manager whether to commit or abort—i.e., until the 2PC transaction manager responds the resource will stay locked, unavailable to anyone. It is assumed in this model that the TM will eventually respond.

Unfortunately, in a distributed cross-enterprise Internet situation, the classic 2PC model does not work very effectively. These transactions are crossing enterprise boundaries and are susceptible to various failures that don't exist when the transactions are bounded within an enterprise. It is possible for a transaction to proceed through all steps, then mysteriously halt prior to final commit—the communication path between client and enterprise may be interrupted, the client may go offline, etc. In a 2PC system, an administrator has some direct control over the 2PC transaction manager. Worst case, the administrator may have to force the 2PC transaction manager back up to cleanly resolve the resource managers' pending transactions. However, this presents a problem when the transaction manager owning the transaction is not only remote, but additionally belongs to another company.

For this reason, according to one embodiment, each e-DTP transaction manager 510 is intended to function as the owner of a 2PC transaction bounded by the enterprise 500 that contains it. Whenever a tentative hold is requested, the e-DTP transaction manager 510 acquires a lock on that resource item and releases the lock when either some e-DTP transaction completes or there are no longer any holds on that resource. This is desirable since the resource managers 520 may be responding to other transaction managers that want access to the resource managers' resources—the situation could occur where multiple clients have a tentative hold on a resource item (e.g., a seat) that suddenly disappears when a non-e-DTP transaction manager grabs the seat using another transaction processing protocol, such as 2PC. While not satisfactory, potential mechanisms to resolve such a situation include the e-DTP transaction manager 510 having a tighter coupling to the resource managers 520 or the e-DTP transaction manager 510 being notified by any other transaction managers of pending transactions.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method comprising:
receiving information regarding an atomic distributed transaction, the atomic distributed transaction representing an aggregation of a plurality of discrete transactions for resource items that span a plurality of network resources;
placing a tentative hold on each of the plurality of resource items by causing a tentative hold record to be created and associated with each of the plurality of discrete transactions, the tentative holds operating in a non-mutually exclusive manner, thereby allowing the same resource item to be tentatively held by more than one transaction; and
after successfully gaining the tentative holds on each of the plurality of resource items and receiving a confirmation regarding the atomic distributed transaction, attempting to direct the completion of the atomic distributed transaction by conventional means.

2. The method of claim 1, wherein said attempting to direct the completion of the atomic distributed transaction by conventional means comprises initiating conventional Two-Phase Commit (2PC) prepare and commit processing for each of the plurality of discrete transactions.

3. The method of claim 1, further comprising receiving a notification indicating one of the plurality of discrete transactions are no longer possible.

4. The method of claim 1, wherein one or more of the tentative hold records are stored at an intermediate server that is not within the enterprise offering the resource item.

5. The method of claim 1, wherein the plurality of network resources comprise database systems of a plurality of different enterprises.

6. A method comprising:
receiving information regarding a distributed transaction from an originating application, the distributed transaction involving a plurality of items spanning a plurality of network resources; and
initiating a tentative-hold processing stage by requesting that a plurality of resource managers residing on one or more remote servers and participating in the distributed transaction each tentatively hold an item of the plurality of items involved in the distributed transaction and store call back information identifying a return communication path to the originating application, the tentative hold records operating in a non-mutually exclusive manner, thereby allowing items associated with the one or more remote servers to be tentatively held by more than one application.

7. The method of claim 6, wherein at least two of the remote servers are associated with different enterprises.

8. The method of claim 6, further comprising receiving a commitment corresponding to the distributed transaction from the originating application; and responsive to the commitment, initiating a two-phase commit processing stage by directing the resource managers to reserve the items during which the resource managers reserve the items and notifying, via corresponding call back information, other applications having a tentative hold on the same items that their respective tentative holds have been suspended.

9. A method comprising:
receiving, from a first client, a first request associated with a first discrete transaction, the first request soliciting a non-mutually exclusive hold on a resource item; the resource item being part of a first atomic distributed transaction that spans a plurality of network resources;
maintaining a first non-mutually exclusive hold on the resource item until an exclusive lock is obtained on the resource item or for a predetermined amount of time, whichever occurs first, by causing a first tentative hold record to be created and associated with the resource item and initiating a first timeout associated with the first tentative hold record;
receiving, from a second client, a second request associated with a second discrete transaction, the second request soliciting a non-mutually exclusive hold on the resource item, the resource item being part of a second atomic distributed transaction;
maintaining a second non-mutually exclusive hold on the resource item until an exclusive lock is obtained on the resource item or for a predetermined amount of time, whichever occurs first, by causing a second tentative hold record to be created and associated with the resource item and initiating a second timeout associated with the second tentative hold record;
receiving, from the first client, a third request associated with the first discrete transaction, the third request asking that completion of the first discrete transaction commence; and
responsive to the third request, suspending the second non-mutually exclusive hold and granting an exclusive lock on the resource item to the first discrete transaction.

10. The method of claim 9, wherein at least two network resources of the plurality of network resources are associated with different enterprises.

11. The method of claim 9, further comprising:
storing call back information associated with an application originating the second discrete transaction; and
notifying the application regarding the suspension of the second non-mutually exclusive hold.

12. The method of claim 9, further comprising in response to a timeout on the exclusive lock, recommencing the second non-mutually exclusive hold on behalf of the second discrete transaction.

13. A distributed transaction processing system comprising:
a distributed transaction coordinator executing on a first client system, the distributed transaction coordinator to place non-mutually exclusive holds on each of a plurality of resource items associated with an atomic distributed transaction that spans a plurality of network resources and to commence completion of the atomic distributed transaction by obtaining exclusive locks on each of the plurality of resource items after non-mutually exclusive holds have been successfully granted on each of the plurality of resource items; and
a distributed transaction manager executing on a server system communicatively coupled with a plurality of client systems including the first client system, the distributed transaction manager to maintain a plurality of non-mutually exclusive holds for each of a plurality of resource items associated with the server system and to grant only one exclusive lock per single resource item of the plurality of resource items at a given time in response to requests from distributed transaction coordinators.

14. The distributed transaction processing system of claim 13, wherein the distributed transaction coordinator includes a Two-Phase Commit transaction coordinator.

15. The distributed transaction processing system of claim 13, further comprising one or more Two-Phase Commit resource managers communicatively coupled with the distributed transaction manager.

16. A machine-readable medium having stored thereon data representing sequences of instructions, the sequences of instructions which, when executed by a processor, cause the processor to:
receive information regarding an atomic distributed transaction, the atomic distributed transaction representing an aggregation of a plurality of discrete transactions for individual resource items that span a plurality of network resources;
place a tentative hold on each of the plurality of individual resource items by causing a tentative hold record to be created and associated with each of the plurality of discrete transactions, the tentative holds operating in a non-mutually exclusive manner, thereby allowing the same resource item to be tentatively held by more than one interested party; and
after successfully gaining the tentative holds on each of the plurality of individual resource items and receiving a confirmation regarding the atomic distributed transaction, attempt to direct the completion of the atomic distributed transaction by conventional means.

17. The machine-readable medium of claim 16, wherein said attempt to direct the completion of the atomic distributed transaction by conventional means comprises initiating conventional Two-Phase Commit (2PC) prepare and commit processing for each of the plurality of discrete transactions.

18. The machine-readable medium of claim 16, wherein one or more of the tentative hold records are stored at an intermediate server that is not within the enterprise offering the resource item.

19. The machine-readable medium of claim 16, wherein the plurality of network resources comprise database systems of a plurality of different enterprises.

20. A machine-readable medium having stored thereon data representing sequences of instructions, the sequences of instructions which, when executed by a processor, cause the processor to:
receive, from a first client, a first request associated with a first discrete transaction, the first request soliciting a non-mutually exclusive hold on a resource item; the resource item being part of a first atomic distributed transaction that spans a plurality of network resources;
maintain a first non-mutually exclusive hold on the resource item until an exclusive lock is obtained on the resource item or for a predetermined amount of time, whichever occurs first, by causing a first tentative hold record to be created and associated with the resource item and initiating a first timeout associated with the first tentative hold record;
receive, from a second client, a second request associated with a second discrete transaction, the second request soliciting a non-mutually exclusive hold on the resource item, the resource item being part of a second atomic distributed transaction;
maintain a second non-mutually exclusive hold on the resource item until an exclusive lock is obtained on the resource item or for a predetermined amount of time, whichever occurs first, by causing a second tentative hold record to be created and associated with the resource item and initiating a second timeout associated with the second tentative hold record;
receive, from the first client, a third request associated with the first discrete transaction, the third request asking that completion of the first discrete transaction commence; and
responsive to the third request, suspend the second non-mutually exclusive hold and grant an exclusive lock on the resource item to the first discrete transaction.

21. The machine-readable medium of claim 20, wherein at least two network resources of the plurality of network resources are associated with different enterprises.

22. The machine-readable medium of claim 20, wherein the sequences of instructions further include instructions which, when executed by the processor, cause the processor to:
store call back information associated with an application originating the second discrete transaction; and
notify the application regarding the suspension of the second non-mutually exclusive hold.

23. The method of claim 20, wherein the sequences of instructions further include instructions which, when executed by the processor, cause the processor to recommence the second non-mutually exclusive hold on behalf of the second discrete transaction in response to a timeout on the exclusive lock.
